(19) United States
(12) Patent Application Publication
(10) Pub. No.: US 2017/0105118 A1
(43) Pub. Date: Apr. 13, 2017

(54) APPARATUS AND METHOD FOR ENHANCING PRIVACY

(71) Applicant: CONFIVOX INC., Toronto (CA)

(72) Inventor: John David LEE, Toronto (CA)

(21) Appl. No.: 15/285,812

(22) Filed: Oct. 5, 2016

Related U.S. Application Data
(60) Provisional application No. 62/240,840, filed on Oct. 13, 2015.
(60) Provisional application No. 62/304,550, filed on Mar. 7, 2016.

(51) Int. Cl. H04W 12/02; H04M 1/02

(52) U.S. Cl. CPC H04W 12/02; H04M 1/026

(57) ABSTRACT

An apparatus for enhancing privacy during operation of a portable electronic device are provided. The apparatus includes a privacy shield and an attachment mechanism to connect the privacy shield to the portable electronic device.

### FIELD

The present specification relates generally to an apparatus for use with a mobile device and more specifically relates to an apparatus for enhancing privacy for use with a mobile device.

### BACKGROUND

The evolution of computers is currently quite active in the portable electronic device environment. As the portable electronic devices evolve, portable electronic devices have adopted various different forms and functionality. One general trend is that portable electronic devices configured for mobile communications, such as mobile phones, are being put into ever smaller cases as microphone and other technology allows for the portable electronic devices to be physically further from a sound source without substantial degradation of sound quality.

### SUMMARY

In accordance with an aspect of the invention, there is provided an apparatus for enhancing privacy for use with a mobile device. The apparatus includes a privacy shield for blocking sound from a mouth of a user. In addition, the apparatus includes a sound guide disposed on the privacy shield. The sound guide is for directing sound to from the mouth to a microphone of the portable electronic device. Furthermore, the apparatus includes an attachment mechanism configured to attach the privacy shield to the portable electronic device.

The apparatus may further include a moveable element connecting the privacy shield to the attachment mechanism. The moveable element configured to move the privacy shield from a blocking position to a storage position.

The moveable element may include a track for the privacy shield to slide thereon.

The moveable element may include a hinge to provide pivotal movement of the privacy shield relative to the attachment means.

The sound guide may include a surface configured to reflect sound.

The privacy shield may be collapsible for storage.

The privacy shield may cover lips of a user to obstruct lip reading.

The attachment mechanism may be a hook and pile system.

The attachment mechanism may include an attachment magnet configured to interact with a device magnet.

The attachment mechanism may include a screw configured to be secured to the portable electronic device.

In accordance with an aspect of the invention, there is provided another apparatus for enhancing privacy during operation of a portable electronic device. The apparatus includes a privacy shield for blocking sound from a mouth of a user. In addition, the apparatus includes an attachment mechanism configured to attach to the portable electronic device. Furthermore, the apparatus includes a hinge connecting the privacy shield and the attachment mechanism. The hinge is configured to provide pivotal movement of the privacy shield between a first position and a second position.

The hinge may be a flexible material.

The flexible material may be one of a plastic, rubber, or silicone.

The first position may be for storing the privacy shield.

The first position may store the privacy shield against a touchscreen of the portable electronic device.

The privacy shield may be configured to allow for operation of the touchscreen when in the first position.

The hinge may be further configured to provide pivotal movement of the privacy shield to a third position. The third position for storing the privacy shield against a back of the portable electronic device.

In accordance with an aspect of the invention, there is provided another apparatus for enhancing privacy during operation of a portable electronic device. The apparatus includes a phone holder configured to hold a phone. In addition, the apparatus includes a phone holder track disposed on the phone holder. Furthermore, the apparatus includes a privacy shield. The apparatus also includes a shield track disposed in a channel on the privacy shield. The shield track is configured to slidably engage the phone holder track. The phone holder is configured to slide between a storage position and a use position. The apparatus further includes a hinge disposed within the privacy shield. The hinge is configured to provide pivotal movement of a portion of the privacy shield between a first position and a second position.

The privacy shield may be engaged from both the first end and the second end of the phone holder. the first end opposite the second end.

The apparatus may include further comprising clips disposed on the privacy shield for storing items.

### BRIEF DESCRIPTION OF THE DRAWINGS

Reference will now be made, by way of example only, to the accompanying drawings in which:

FIG. 1 is a representation of an apparatus for a portable electronic device in a storage position in accordance with an embodiment;

FIG. 2 is a representation of the apparatus shown in FIG. 1 in a blocking position;

FIG. 3 is a representation of an apparatus of a portable electronic device in a storage position in accordance with another embodiment;

FIG. 4 is a representation of the apparatus shown in FIG. 3 in an intermediate position;

FIG. 5 is a representation of the apparatus shown in FIG. 3 in a blocking position;

FIG. 6 is a representation of an apparatus for a portable electronic device in a storage position in accordance with another embodiment;

FIG. 7 is a representation of the apparatus shown in FIG. 6 in an intermediate position;

FIG. 8 is a representation of an apparatus for a portable electronic device in accordance with another embodiment;

FIG. 9 is a representation of an apparatus shown in FIG. 8 in use with a portable electronic device in a first configuration;

FIGS. 10a-b is a representation of an apparatus shown in FIG. 8 in use with a portable electronic device in other configurations;

FIGS. 11a-b is a representation of an apparatus for a portable electronic device in accordance with another embodiment;

FIGS. 12a-b is a representation of an apparatus for a portable electronic device in accordance with another embodiment;

FIG. 13 is a representation of an apparatus for a portable electronic device in accordance with another embodiment;

FIG. 14 is a view of the phone holder of the embodiment shown in FIG. 13;

FIG. 15 is a view of the privacy shield of the embodiment shown in FIG. 13;

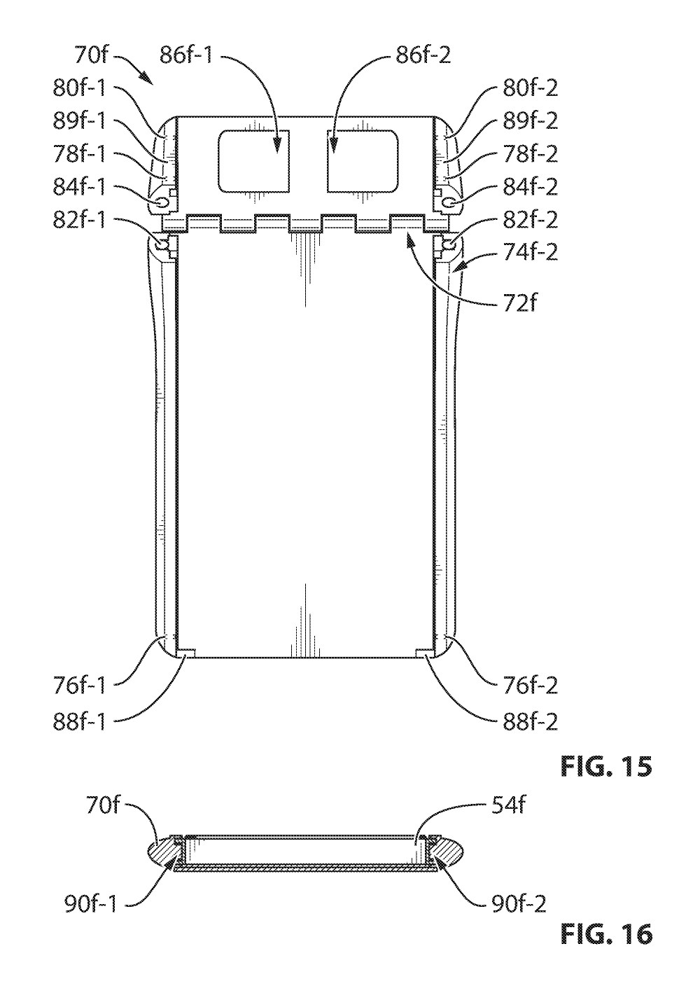

FIG. 16 is a cross sectional view of the apparatus of the embodiment shown in FIG. 13 about the line 16-16;

FIG. 17 is a representation of an apparatus shown in FIG. 13 in a first configuration;

FIGS. 18a-e is a representation of an apparatus shown in FIG. 13 in other configurations; and

FIG. 19 is a representation of an apparatus for a portable electronic device in accordance with another embodiment.

### DETAILED DESCRIPTION OF THE EMBODIMENTS

As used herein, any usage of terms that suggest an absolute orientation (e.g. “top”, “bottom”, “front”, “back”, etc.) are for illustrative convenience and refer to the orientation shown in a particular figure. However, such terms are not to be construed in a limiting sense as it is contemplated that various components will, in practice, be utilized in orientations that are the same as, or different than those described or shown.

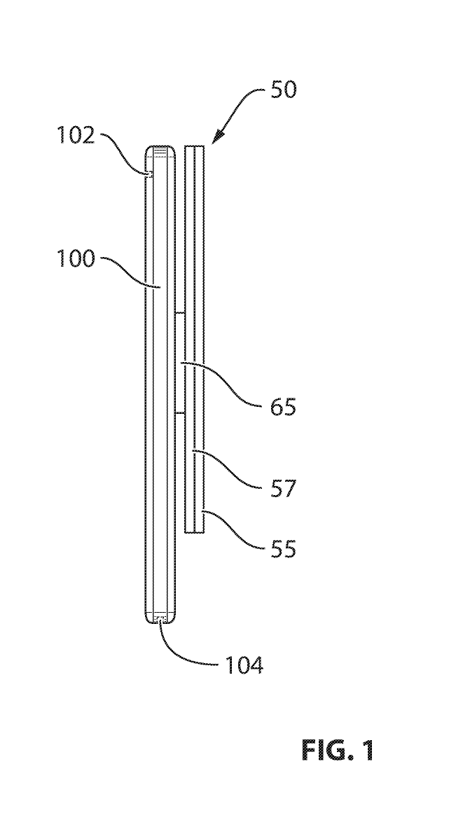

Referring to FIG. 1, a representation of an apparatus 50 for enhancing privacy during operation of a portable electronic device 100 is generally shown. It is to be understood that the apparatus 50 is purely exemplary and it will be apparent to those skilled in the art that variations are contemplated. In the present embodiment, the apparatus 50 includes a privacy shield 55, a moveable element 57, a sound guide 60, and an attachment mechanism 65.

It is to be appreciated that the portable electronic device 100 is not particularly limited and that the apparatus 50 can be configured for use on a wide variety of portable electronic devices 100. For example, the portable electronic device 100 can include, without limitation, a cellular telephone, a portable email paging device, a portable audio recorder/player, a portable video recorder/player, a personal digital assistant, a tablet computer or any other device where enhancing privacy may be desired. In the present embodiment, the portable electronic device 100 includes a speaker 102 generally configured to output audio to an ear of a user and a microphone 104 for receiving audio input from a user. In other embodiments where audio output is not required, such as for an audio recording device, a person of skill in the art with the benefit of this description will recognize that the portable electronic device 100 can be modified such that the speaker 102 is omitted.

The privacy shield 55 is generally configured to block sound from the mouth of a user. Accordingly, the privacy shield 55 is generally positioned directly in front of the mouth in close proximity. In the present embodiment, the privacy shield 55 is made of plastic, but other materials can be used. In particular, the privacy shield 55 is made from an opaque plastic material. It is to be appreciated by a person of skill in the art with the benefit of this description that by using an opaque material, the privacy shield 55 can cover the mouth of a user to limit the range of angles from which the lips can been read to further enhance privacy. It is to be understood that the privacy shield 55 is not particularly limited and that variations are contemplated. As an example of a variation, the privacy shield can be modified to include sound absorbing materials to dampen sounds from the mouth. For example, the privacy shield can be lined with the sound absorbing material.

In the present embodiment, it is to be appreciated by a person of skill in the art that the privacy shield 55 can be additionally configured to reduce external noise, such as environmental noise, from reaching the microphone 104. For example, the privacy shield 55 can include sound absorbing materials on the exterior surface or be shaped to deflect sound away from the microphone 104.

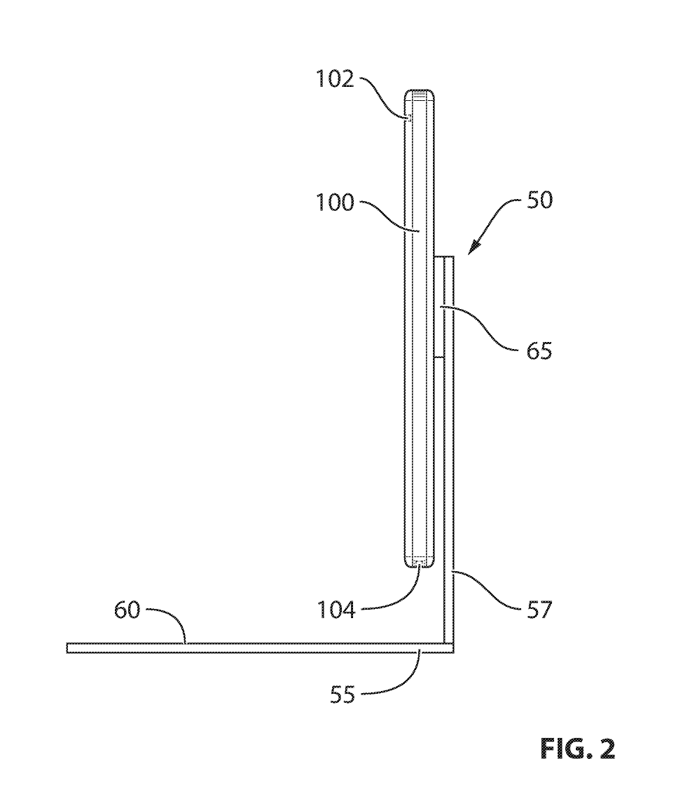

In the present embodiment, the optional moveable element 57 is generally configured to connect the privacy shield 55 to the attachment mechanism 65. The moveable element 57 provides a translational motion along a track as well as pivot point such that the privacy shield 55 can move from the storage position shown in FIG. 1 to the blocking position shown in FIG. 2. It is to be appreciated that the moveable element 57 is not particularly limited and that variations are contemplated. For example, the moveable element 57 can include a linear guide with ball bearings to provide translational motion and a hinge disposed proximate to the bottom end of the moveable element 57 to provide the pivotal motion. As an example of a variation, the moveable element 57 can alternatively include a track that provides for frictional sliding. It is to be appreciated by a person of skill in the art with the benefit of this description that additional features can be added to hold the moveable element 57 in one or both of the storage position or the blocking position, such as by using magnets, clips, or an over the top mechanism. For example, two sturdy and flexible plastic bands which can roll up/extend when one device moves can be used to hold a position.

In the present embodiment, when the moveable element 57 is in the storage position, the apparatus 50 is generally configured to allow access to substantially most of the input and output devices of the portable electronic device 100. For example in the present embodiment, the microphone 104 is not obstructed when the moveable element 57 is in the storage position such that the portable electronic device 100 can be used without moving the privacy shield 55, such as for convenience when a conversation that does call for a high level of privacy.

It is to be appreciated by a person of skill in the art with the benefit of this description that the moveable element 57 is optional and can be omitted. For example, in some embodiments, the apparatus can be a separate add-on device that can be attached in the blocking position and removed when not in use.

The sound guide 60 is disposed on the privacy shield 55 and generally configured to direct sound from the mouth of the user to the microphone 104 of the portable electronic device 100. It is to be appreciated that the sound guide is not particularly limited. For example, in the present embodiment, the sound guide 60 comprises the surface of the privacy shield 55 that is configured to reflect sound waves and angled such that sound would generally be reflected from the mouth and directed toward the microphone 104. It is to be appreciated by a person of skill in the art that in embodiments where a sound absorbing material is used in the privacy shield 55, the sound guide 60 is used to reduce the dampening effect for the microphone 104. In other embodiments, the sound guide 60 can include a plurality of ridges configured to direct sound from the mouth to the microphone 104.

The attachment mechanism 65 is generally configured to attach the privacy shield 55 to the portable electronic device 100. The manner by which the attachment mechanism 65 attaches the privacy shield 55 to the portable electronic device 100 is not particularly limited. The attachment mechanism 65 can allow for rapid attachment to or detachment from the portable electronic device 100. For example, the attachment mechanism 65 can include a hook and pile fastening system, or a magnetic attachment system. Alternatively, attachment mechanism 65 can provide a more permanent attachment of the apparatus 50 to the portable electronic device 100. For example, the attachment mechanism 65 can include a screw for securing the apparatus 50 to the portable electronic device. It is to be appreciated by a person of skill in the art with the benefit of this description that the attachment mechanism 65 can be configured to be universally operable with a large number of portable electronic devices or to be specifically designed for one type of device.

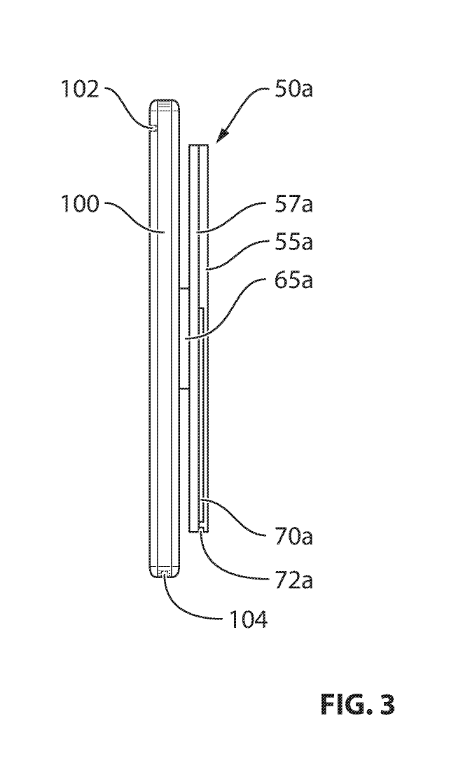

Referring now to FIGS. 3 to 5, another embodiment of an apparatus 50a for enhancing privacy during operation of a portable electronic device 100 is generally shown. Like components of the apparatus 50a bear like reference to their counterparts in the apparatus 50, except followed by the suffix “a”. For example, the apparatus 50a includes a privacy shield 55a, a moveable element 57a, a sound guide 60a, and an attachment mechanism 65a. In addition, the privacy shield 55a further includes a top flap 70a and an end flap 72a.

It is to be appreciated by person of skill in the art with the benefit of this description that the apparatus 50a is substantially similar to the apparatus 50 with the addition of the top flap 70a and the end flap 72a disposed on the main portion of the privacy shield 55a. The top flap 70a is not particularly limited and can be constructed from similar materials as the privacy shield and generally configured to block sound from the mouth of the user that may escape around the main portion of the privacy shield 55a. Similarly, the end flap 72a is not particularly limited and can be constructed from similar materials as the privacy shield and generally configured to block sound from the mouth of the user that may escape around the main portion of the privacy shield 55a.

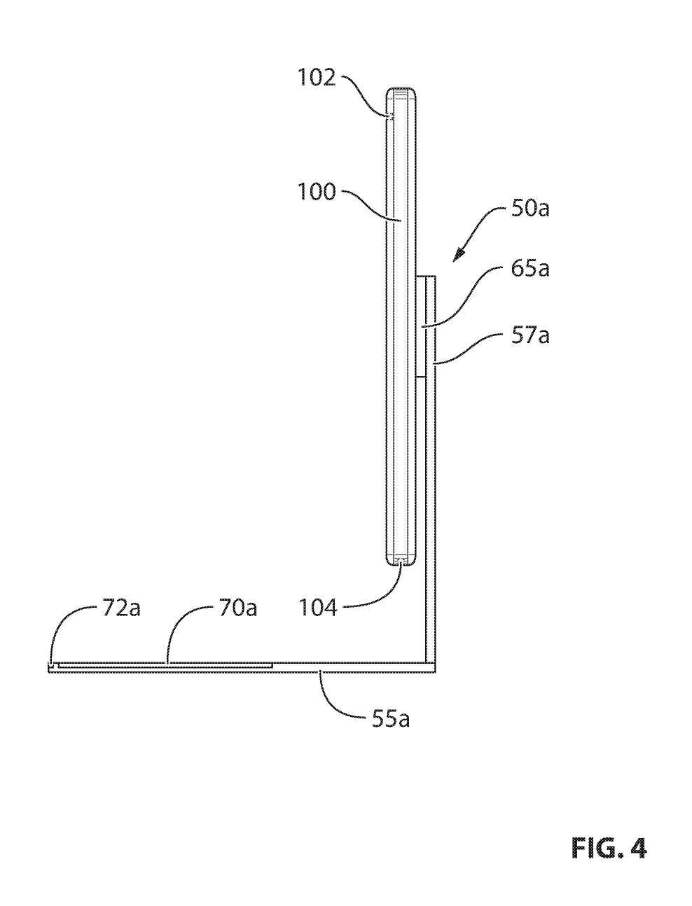

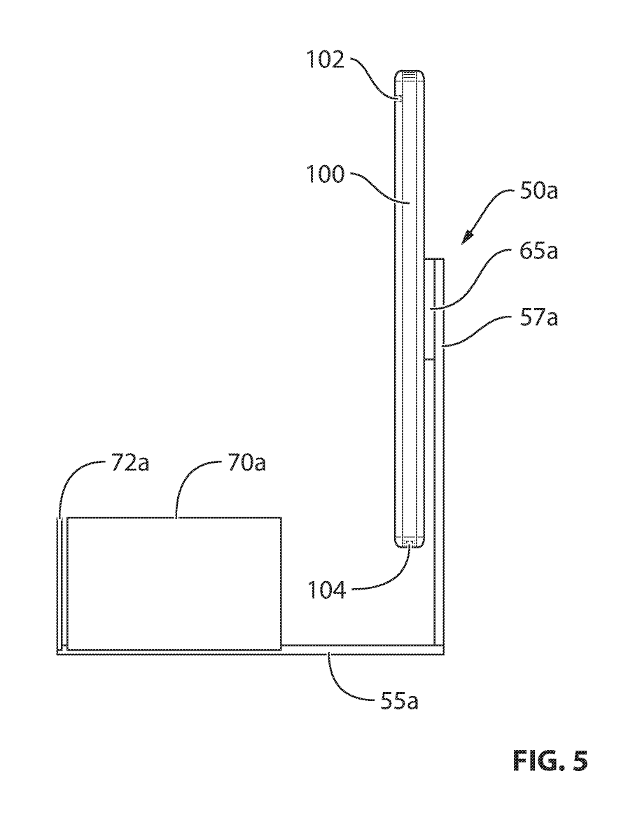

In the present embodiment, the top flap 70a and the end flap 72a are both pivotally attached to the main portion of the privacy shield 55a such that the top flap 70a and the end flap 72a can be folded to allow the privacy shield 55a to be collapsed for storage. Accordingly, in the present embodiment, the moveable element 57a provides a translational motion along a track as well as pivot point such that the privacy shield 55a can move from the storage position shown in FIG. 3 to an intermediate position shown in FIG. 4. The top flap 70a and the end flap 72a can be pivoted open so that the apparatus is converted to the blocking position shown in FIG. 5.

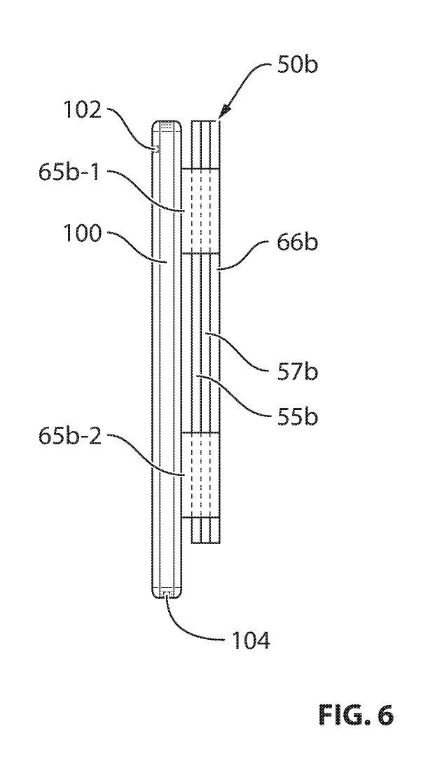

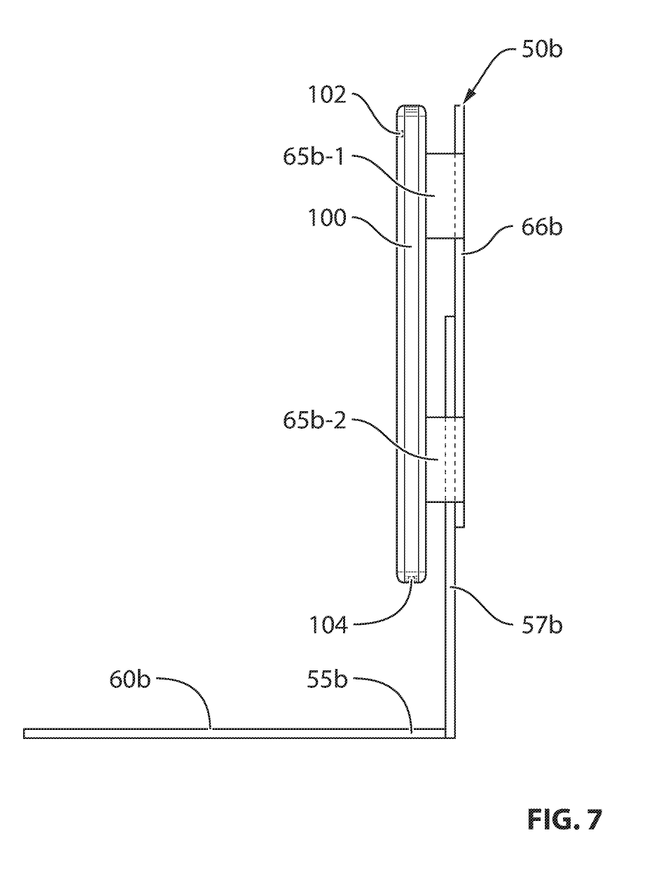

Referring now to FIGS. 6 and 7, another embodiment of an apparatus 50b for enhancing privacy during operation of a portable electronic device 100 is generally shown. Like components of the apparatus 50b bear like reference to their counterparts in the apparatus 50, except followed by the suffix “b”. For example, the apparatus 50b includes a privacy shield 55b, a moveable element 57b, and a sound guide 60b. In the present embodiment, the apparatus 50b includes a pair of attachment mechanisms 65b-1 and 65b-2 for attaching a mounting plate 66b.

It is to be appreciated by person of skill in the art with the benefit of this description that the apparatus 50b is substantially similar to the apparatus 50 except that the moveable element is slidably connected to the mounting plate 66b instead of directly to the portable electronic device 100.

In the present embodiment, the top flap 70a and the end flap 72a are both pivotally attached to the main portion of the privacy shield 55a such that the top flap 70a and the end flap 72a can be folded to allow the privacy shield 55a to be collapsed for storage. Accordingly, in the present embodiment, the moveable element 57a provides a translational motion along a track as well as pivot point such that the privacy shield 55a can move from the storage position shown in FIG. 3 to an intermediate position shown in FIG. 4. The top flap 70a and the end flap 72a can be pivoted open so that the apparatus is converted to the blocking position shown in FIG. 5.

It is to be re-emphasized that the structures described are a non-limiting representation only. In particular, it is to be understood that various features of the embodiments described can be combined or modified. For example, it is to be appreciated by a person of skill in the art with the benefit of this description that either one of the top flap 70a or the end flap 72a of the apparatus 50a can be omitted. As another example of a variation, the top flap 70a and/or the end flap 72a of the apparatus 50a can be incorporated into the apparatus 50b. Further variations can include the addition of more flaps and sound guides to the apparatus.

As another example of a variation, it is to be appreciated that the apparatus 50 can be directly built into a portable electronic device as an additional feature of the device. In such a variation, it may be possible to omit the attachment mechanism 65 if the apparatus were to be formed on a unitary body of the portable electronic device 100.

As another example of a variation, it is to be appreciated that the apparatus 50 can be converted from a storage position to a blocking position or vice versa using other means, such as a motor, or a spring. Furthermore, the other means can either be manually operated or via an electronic signal from the portable electronic device.

Various advantages will now be apparent to a person of skill in the art. Of note is the ability to carry out a conversation in a public place with enhanced privacy. It is to be understood that the apparatus 50 can be designed to be sufficiently compact to fit within standard carrying cases. Accordingly, the apparatus 50 provides a compact solution that does not require substantial additional storage when carrying a portable electronic device. Therefore, it is to be appreciated that this ability would be especially beneficial when, for example, conducting a business call while on public transit, while walking down a public street, or while in an airport waiting area.

Another advantage would be that background noise can be substantially reduced during a phone call to improve call quality. Furthermore, in embodiments with a moveable element 57, it is to be appreciated with the benefit of this description that the moveable element 57 can be used to provide adjustments of the privacy shield 55 to accommodate for various users as well as portable electronic devices.

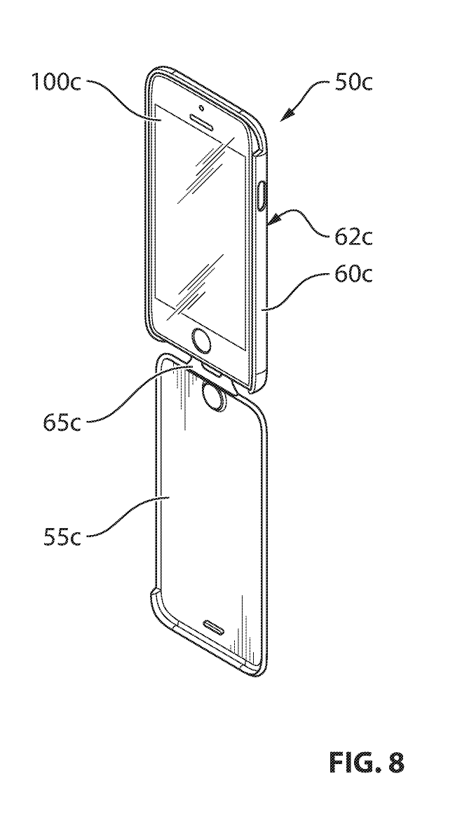

Referring to FIG. 8, a representation of another embodiment of an apparatus 50c for enhancing privacy during operation of a portable electronic device is generally shown. It is to be understood that the apparatus 50c is purely exemplary and it will be apparent to those skilled in the art that variations are contemplated. In the present embodiment, the apparatus 50c includes a privacy shield 55c, an attachment mechanism 60c, and a hinge 65c.

The privacy shield 55c is generally configured to block sound from the mouth of a user of the portable electronic device. Accordingly, the privacy shield 55c is generally positioned directly in front of the mouth of the user and in close proximity. In the present embodiment, the privacy shield 55c is moveable between a position for storage and a position for covering the mouth of the user. In the present embodiment, the privacy shield 55c is made from a tinted poly carbonate plastic. However, it is to be appreciated by a person of skill in the art that the material of the privacy shield 55c is not particularly limited. For example, the privacy shield 55c can be modified to be made from rubber, metal, or other composite material capable of blocking and/or dampening sound. In other embodiments, the privacy shield 55c can be opaque or clear.

The attachment mechanism 60c is generally configured to attach the privacy shield 55c to a portable electronic device 100c. The manner by which the attachment mechanism 60c attaches to the portable electronic device is not particularly limited. In the present embodiment, the attachment mechanism 60c is made from a flexibly resilient material that is configured to wrap around the edge of the portable electronic device. For example, the attachment mechanism 60c can be made from the same plastic material as the privacy shield 55c. In other embodiments, the attachment mechanism 60c can be made from different materials such as rubber, silicone, or metal. Furthermore, the attachment mechanism 60c can be connected to an optional casing 62c for protecting the portable electronic device.

In the present embodiment, the attachment mechanism 60c is designed for a specific portable electronic device 100c and includes openings to allow for access to various controls of the portable electronic device 100c. It is to be appreciated that the attachment mechanism 60c is not particularly limited and can be modified for other portable electronic devices. For example, several modified attachment mechanisms can be designed such that each design is dimensioned accordingly and configured to attach to a specific portable electronic device. In other embodiments, the attachment mechanism 60c can be configured to be universally adaptable to multiple portable electronic devices. For example, the attachment mechanism 60c can include various adjustments that allow it to wrap around portable electronic devices within a specified range of length, width, and/or thickness. Accordingly, but allowing the attachment mechanism 60c to be adjustable, most common models of portable electronic devices, such as smartphones, can be fitted with the apparatus 50c.

The hinge 65c connects the privacy shield 55c and the attachment mechanism 60c. Furthermore, the hinge 65c is generally configured to provide pivotal movement of the privacy shield 55c relative to the portable electronic device between at least two positions. In the present embodiment, the hinge 65c is a flexible material connecting the privacy shield 55c and the attachment mechanism 60c and provides a substantially pivotal motion by deforming. The material of the hinge 65c is not particularly limited and can include any material with the proper mechanical properties to allow for a rotational motion between the privacy shield 55c and the attachment mechanism 60c. For example, the hinge 65c can be made from a plastic, rubber, or silicone. In other embodiments, the hinge 65c can include a pin-type hinge.

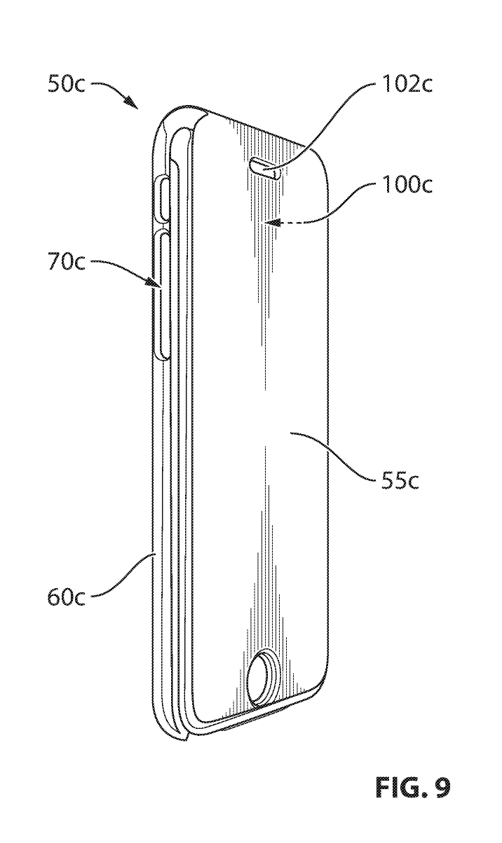

Referring to FIG. 9, the apparatus 50c is generally shown in use with a portable electronic device 100c where the privacy shield 55c is in a position for storage. It is to be appreciated that the portable electronic device 100c is not particularly limited and that the apparatus 50c can be configured for use on a wide variety of portable electronic devices 100c as discussed above. For example, the portable electronic device 100c can include, without limitation, a cellular telephone, a portable email paging device, a portable audio recorder/player, a portable video recorder/player, a personal digital assistant, a tablet computer or any other device where enhancing privacy may be desired. In the present embodiment, the portable electronic device 100c includes a speaker 102c generally configured to output audio to an ear of a user and a microphone 104c for receiving audio input from a user. In other embodiments where audio output is not required, such as for an audio recording device, a person of skill in the art with the benefit of this description will recognize that the portable electronic device 100c can be modified such that the speaker 102c is omitted.

In the present embodiment, the privacy shield 55c is stored against a touchscreen of the portable electronic device 100c as shown in FIG. 9. Accordingly, the privacy shield 55c also serves as a screen protector for the touchscreen of the portable electronic device 100c. For example, when in this storage position, the privacy shield 55c can protect the portable electronic device 100c from scratches as well as dampen any shock to the portable electronic device 100c, such as from a fall. It is to be appreciated by a person of skill in the art with the benefit of this description that when the apparatus 50c includes the optional casing 62c, the apparatus 50c can form a shell encasing the portable electronic device 100c when the privacy shield 55c is in the storage position shown in FIG. 2 to provide protection on substantially all sides of the portable electronic device 100c. In the present embodiment, the apparatus 50c can also include an opening 70c for allowing access to portions of the portable electronic device 100c. For example, the opening 70c can allow for access to various control buttons, such as a volume control, of the portable electronic device 100c. Other openings can also allow sound to be emitted from a speaker 102c or for sound to be received by a microphone 104c. In addition, the privacy shield 55c can be made from a material that allows for the operation of the touchscreen through the privacy shield 55c. For example, the tinted polycarbonate plastic can be tinted such that light from the touchscreen is still easily viewable by a user through the privacy shield 55c while the polycarbonate plastic allows for touch inputs to be detectable by the touchscreen underneath.

In the present embodiment, the privacy shield 55c is generally configured to couple with the attachment mechanism 60c to encase the portable electronic device 100c as shown in FIG. 9. The manner by which the privacy shield 55c couples to the attachment mechanism is not particularly limited. For example, the privacy shield 55c can snap into place using a resiliently deformable lip (not shown) disposed on at least either one of the privacy shield 55c or the attachment mechanism 60c. In other embodiments, the hinge 65c can be configured to bias the privacy shield 55c to seal against the attachment mechanism 60c. In further embodiments, the privacy shield 55c can be magnetically coupled to the attachment mechanism 60c.

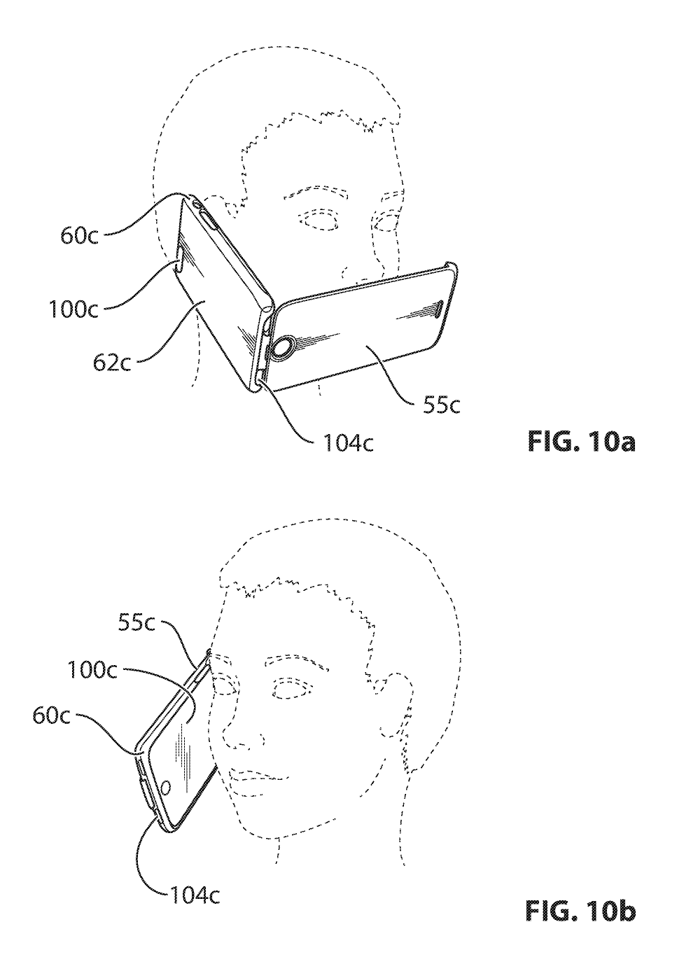

Referring to FIG. 10a, the apparatus 50c is generally shown in use with a portable electronic device 100c where the privacy shield 55c is in a position for covering the mouth of a user of the portable electronic device 100c. In the present embodiment, it is to be appreciated by a person of skill in the art with the benefit of this description that the tint of the privacy shield 55c allowing for operation of the touchscreen can be sufficiently dark obscure the mouth of the user from view. Accordingly, in addition to providing a physical barrier to dampen sound escaping to the ambient environment, the tinting can provide additional protection against third parties being able to read the lips of the user by covering the lips of the user and obstructing the view of the lips. The manner by which the privacy shield 55c remains in the position shown in FIG. 10a is not particularly limited. For example, the privacy shield 55c can be biased toward the position shown in FIG. 9 and that the privacy shield 55c rests on the face of the user.

Referring to FIG. 10b, the apparatus 50c is generally shown in use with a portable electronic device 100c where the privacy shield 55c is in an optional position for storing the privacy shield 55c against the back of the portable electronic device 100c. It is to be appreciated by a person of skill in the art with the benefit of this description that this additional position allows for the user to directly interact with the portable electronic device 100c, such as for operating the touchscreen. The manner by which the privacy shield 55c remains in the position shown in FIG. 10b is not particularly limited. For example, the hinge 65c can be configured to bias the privacy shield 55c toward this position. In further embodiments, the privacy shield 55c can be magnetically coupled, such as to either the portable electronic device 100c, the attachment mechanism 60c, or the casing 62c.

It is to be re-emphasized that the apparatus 50c described above is a schematic, non-limiting representation only and that variations are contemplated. Furthermore, the method of manufacturing the apparatus 50c is not particularly limited. Some examples of manufacturing include using a molding technique and 3D printing. Furthermore, the design of the apparatus 50c can be varied as well. For example, the apparatus 50c can be of a universal design or a device specific design. It is to be appreciated by a person of skill in the art with the benefit of this description that although a universal design can be more versatile, the additional components that allow for adjustability can make the manufacturing process more complicated. In contrast, the manufacturing process for a single rigid design compatible with a specific device may be simply, but the device specific design can become obsolete quickly if the portable electronic device manufacturer changes the dimensions of subsequent new devices.

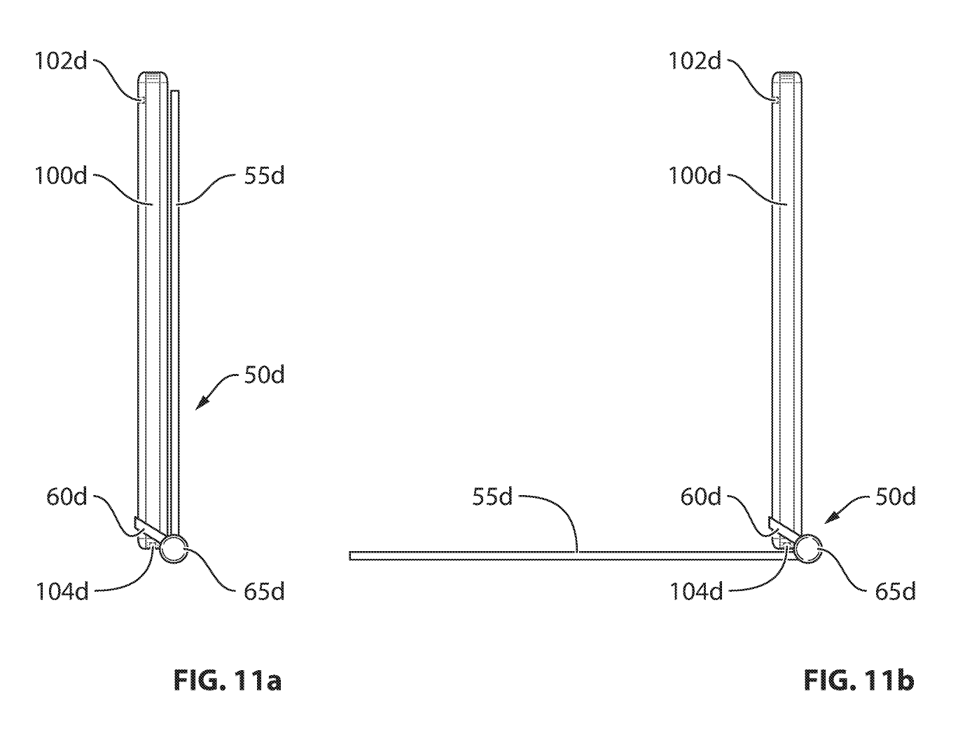

Referring now to FIGS. 11a and 11b, another embodiment of an apparatus 50d for enhancing privacy during operation of a portable electronic device 100d is generally shown. Like components of the apparatus 50d bear like reference to their counterparts in the apparatus 50c, except followed by the suffix “d”. For example, the apparatus 50d includes a privacy shield 55d, a clip 60d, and a hinge 65d.

It is to be appreciated by person of skill in the art with the benefit of this description that the apparatus 50d is substantially similar to the apparatus 50c. In the present embodiment, the privacy shield 55d can be dimensioned differently from the privacy shield 55c; however, the general functionality of the privacy shield 55d remains the same.

In the present embodiment, the attachment mechanism is a clip 60d configured to attach to a portion of the portable electronic device 100d. The manner by which the clip 60d attaches to the portable electronic device 100d is not particularly limited and the clip 60d can be designed for specific device models or can be a universal clip capable of attaching to most portable electronic devices. As shown in FIG. 11a, the clip 60d attaches to the bottom portion of the portable electronic device 100d from the side. It is to be appreciated by a person of skill in the art with the benefit of this description that the clip 60d can be modified to attach from the bottom instead of the side. In the present embodiment, the clip 60d is generally configured for quick attachment and removal.

The hinge 65d is generally configured to allow the privacy shield 55d to move from a storage position against the back of the portable electronic device 100d as shown in FIG. 5 to a position for covering the mouth of the user as shown in FIG. 11b, Since the privacy shield 55d is positioned in front of the mouth of a user, it is possible that the surface of the privacy shield 55d can accumulate saliva droplets as well as other potential debris from the user's mouth. Accordingly, by folding the privacy shield 55d against the back of the portable electronic device 100d, the unclean surface of the privacy shield 55d would not be placed against the touchscreen of the portable electronic device 100d.

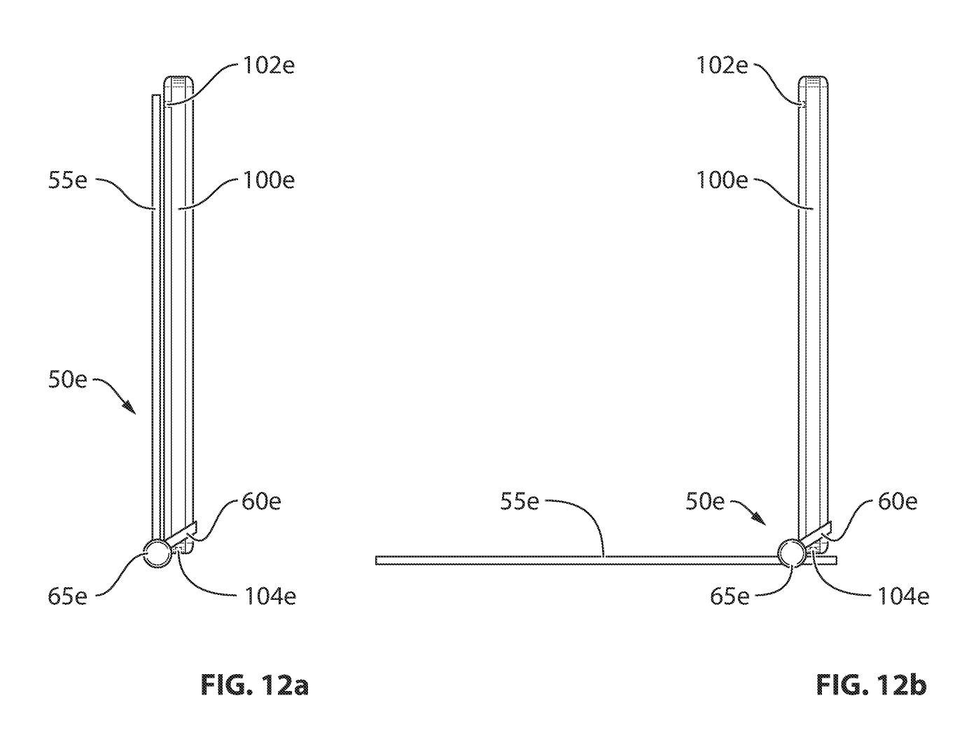

Referring now to FIGS. 12a and 12b, another embodiment of an apparatus 50e for enhancing privacy during operation of a portable electronic device 100e is generally shown. Like components of the apparatus 50e bear like reference to their counterparts in the apparatus 50c, except followed by the suffix “e”. For example, the apparatus 50e includes a privacy shield 55e, a clip 60e, and a hinge 65e.

It is to be appreciated by a person of skill in the art with the benefit of this description that the apparatus 50e is substantially similar to both the apparatus 50c and the apparatus 50d. In particular, the apparatus 50e includes a clip 60e for easy removal and attachment to a portable electronic device 100e. In addition, the privacy shield 55e is stored on the front of the portable electronic device similar to the apparatus 50e.

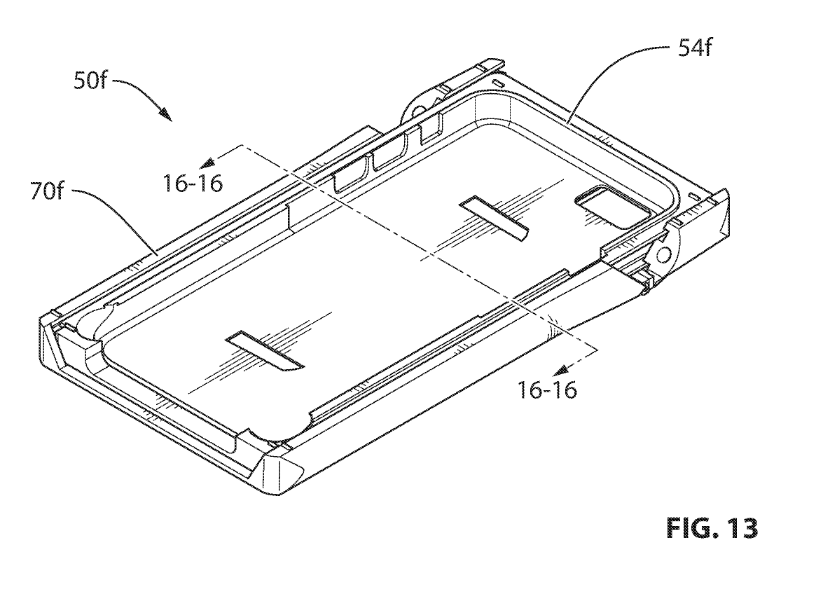

Referring to FIG. 13, a representation of another embodiment of an apparatus 50f for enhancing privacy during operation of a portable electronic device is generally shown. It is to be understood that the apparatus 50f is purely exemplary and it will be apparent to those skilled in the art that variations are contemplated. In the present embodiment, the apparatus 50f includes a phone holder 54f, and a privacy shield 70f.

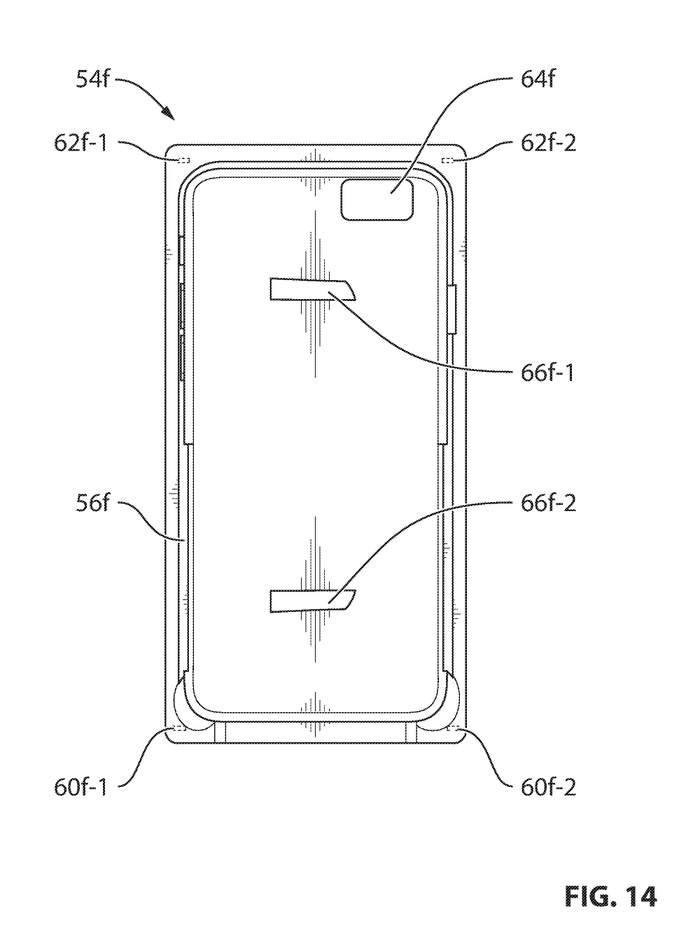

Referring to FIG. 14, the phone holder 54f is shown in greater detail. It is to be understood that the phone holder 54f is purely exemplary and it will be apparent to those skilled in the art that variations are contemplated including other embodiments discussed herein. In the present embodiment, the phone holder 54f includes a lip 56f, extraction dimples 58f, a plurality of case magnets 60f-1, 60f-2, 62f-1, and 62f-2 a camera opening 64f and openings 66f-1 and 66f-2.

The lip 56f is generally configured to attach the phone holder 54f to the portable electronic device 100f. The manner by which the lip 56f attaches the phone holder 54f to the portable electronic device 100f is not particularly limited. In the present embodiment, the lip 56f is made of a flexibly resilient material to snap over an edge of the portable electronic device 100f. It is to be appreciated that this allows for rapid attachment to and/or detachment from the portable electronic device 100f. The lip 56f can be configured to be universally operable with a large number of portable electronic devices having similar dimensions or to be specifically designed for one type of device where the specific dimensions of the device are known. In embodiments, the lip 56f can be substituted with other attachment mechanisms, such as a clip or hooking mechanism. The lip 56f can also be omitted in other embodiments where the portable electronic device can be secured using a friction fit.

In the present embodiment, the optional extraction dimples 58f are generally configured to provide a means for easily removing the portable electronic device 100f from the phone holder 54f. The extraction dimples 58f are not particularly limited and can be disposed at any location around the portable electronic device 100f to allow for greater access with a finger and/or tool for removing the portable electronic device 100f. Although the present embodiment shows two extraction dimples 58f, it is to be appreciated that more of less extraction dimples 58f can be included.

The plurality of case magnets 60f-1, 60f-2, 62f-1, and 62f-2 is embedded within or attached to the phone holder 54f and generally configured to interact with the magnets 76f, 78f, and 80f in the privacy shield 70f to position the phone holder 54f relative to the privacy shield 70f. It is to be appreciated that the case magnets 60f-1, 60f-2, 62f-1, and 62f-2 are not particularly limited and can be any type of ferromagnetic material. For example, the case magnets 60f-1, 60f-2, 62f-1, and 62f-2 can be a rare earth magnet or another type of permanent magnet. In other embodiments, the case magnets 60f-1, 60f-2, 62f-1, and 62f-2 can be substituted with other ferromagnetic materials capable of coupling with the magnets 76f, 78f, and 80f in the privacy shield 70f. In further embodiments, the magnetic positioning system can be omitted or substituted with another mechanism capable of positioning the phone holder 54f relative to the privacy shield 70f.

The camera opening 64f of the phone holder 54f is generally configured to provide an unobstructed line of sight to the camera of the portable electronic device 100f. It is to be appreciated that the position and the dimensions of the camera opening 64f is not particularly limited and would be varied depending on the portable electronic device 100f.

The openings 66f-1 and 66f-2 of the phone holder 54f is generally configured to receive the tabs 89f-1 and 89f-2 of the privacy shield 70f when used in a horizontal stand position as discussed in greater detail below. It is to be appreciated that the position and the dimensions of the openings 66f-1 and 66f-2 not particularly limited and can be varied depending on the dimensions of the privacy shield. In other embodiments, the openings 66f-1 and 66f-2 can be substituted with another attachment mechanism, or omitted in other embodiments.

Referring to FIG. 14, the privacy shield 70f is shown in greater detail. It is to be understood that the privacy shield 70f is purely exemplary and it will be apparent to those skilled in the art that variations are contemplated including other embodiments discussed herein. In the present embodiment, the privacy shield 70f includes a hinge 72f, protrusions 74f, a plurality of shield magnets 76f-1, 76f-2, 78f-1, 78f-2, 80f-1, and 80f-2, hinge magnets 82f-1, 82f-2, 84f-1, and 84f-2, camera openings 86f-1 and 86f-2, and stops 88f-1 and 88f-2 to stop the phone holder 54f from moving too far.

The hinge 72f connects two portions of the privacy shield 70f and is generally configured to provide pivotal movement of the privacy shield 70f between at least two positions. In the present embodiment, the hinge 72f is a pin-type hinge. It is to be appreciated that the hinge is not particularly limited and that in other embodiments, the hinge 72f can be a flexible material, such as plastic, rubber, or silicone, connecting the two portions of the privacy shield 70f to provide a substantially pivotal motion by deforming.

In the present embodiment, the optional protrusions 74f are disposed on the side of the privacy shield 70f and are generally configured to provide for a comfortable grip of the apparatus 50f. In particular, the protrusions 74f allow for the hand to ergonomically hold the apparatus 50f when the portable electronic device is in use. The protrusions 74f are not particularly limited and can be disposed at alternative locations or be modified to be depressions. Although the present embodiment shows two protrusions 74f, it is to be appreciated that more of less protrusions 74f can be included.

The plurality of shield magnets 76f-1, 76f-2, 78f-1, 78f-2, 80f-1, and 80f-2 is embedded within or attached to the privacy shield 70f and generally configured to interact with the case magnets 60f-1, 60f-2, 62f-1, and 62f-2 in the phone holder 54f to position the phone holder 54f relative to the privacy shield 70f. It is to be appreciated that the shield magnets 76f-1, 76f-2, 78f-1, 78f-2, 80f-1, and 80f-2 are not particularly limited and can be any type of ferromagnetic material. For example, the shield magnets 76f-1, 76f-2, 78f-1, 78f-2, 80f-1, and 80f-2 can be a rare earth magnet or another type of permanent magnet. In other embodiments, the shield magnets 76f-1, 76f-2, 78f-1, 78f-2, 80f-1, and 80f-2 can be substituted with other ferromagnetic materials capable of coupling with the case magnets 60f-1, 60f-2, 62f-1, and 62f-2 of the phone holder 54f. In further embodiments, the magnetic positioning system can be omitted or substituted with another mechanism capable of positioning the phone holder 54f relative to the privacy shield 70f.

The hinge magnets 82f-1, 82f-2, 84f-1, and 84f-2 are disposed proximate to the hinge 72f and generally configured to hold the privacy shield 70f in a bent position. When the two portions of the privacy shield 70f are pivoted to an angle, such as 90 degrees in the present embodiment, the hinge magnets 82f-1 and 82f-2 magnetically couple with the hinge magnets 84f-1 and 84f-2 to hold the privacy shield 70f at the angle. It is to be appreciated that the hinge 72f and the privacy shield 70f are not particularly limited and that the angle can be greater or less than 90 degrees in other embodiments. Furthermore, it is to be appreciated that the hinge magnets 82f-1, 82f-2, 84f-1, and 84f-2 are not particularly limited and can be any type of ferromagnetic material. For example, the hinge magnets 82f-1, 82f-2, 84f-1, and 84f-2 can be a rare earth magnet or another type of permanent magnet. In other embodiments, some of the hinge magnets 82f-1, 82f-2, 84f-1, and 84f-2 can be substituted with other ferromagnetic materials capable of coupling with each other. In further embodiments, the hinge 72f can be held in place using mechanical means, such as a spring, a clip, or an adhesive.

The camera openings 86f-1 and 86f-2 of the privacy shield 70f is generally configured to provide an unobstructed line of sight to the camera of the portable electronic device 100f. It is to be appreciated that the position and the dimensions of the camera openings 86f-1 and 86f-2 is not particularly limited and would be varied depending on the portable electronic device 100f. Furthermore, each of the camera openings 86f-1 and 86f-2 are configured to work in conjunction with the camera opening 64f as will be discussed in greater detail below. For example, when the apparatus 50f is in the configuration shown in FIG. 13, the camera opening 64f is substantially in line with the camera opening 86f-2.

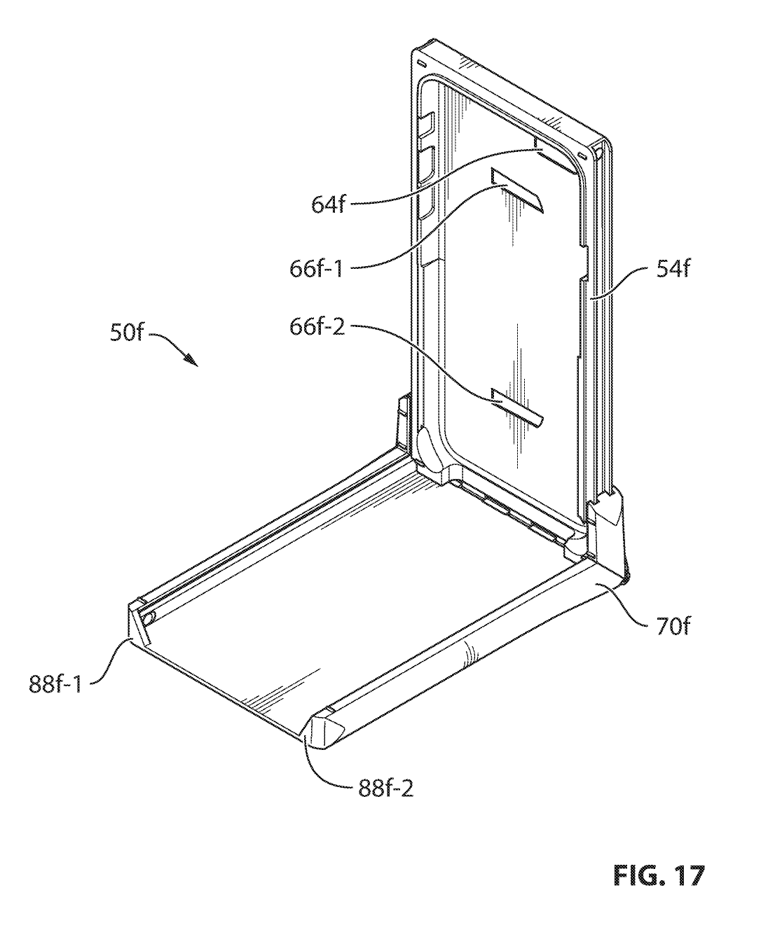

Referring to FIG. 16, the tracks 90f-1 and 90f-2 for guiding the phone holder 54f along the privacy shield 70f is shown in greater detail. In the present embodiment, the tracks 90f-1 and 90f-2 are similar. The privacy shield 70f includes a channel with a ridge substantially in the center. The phone holder 54f is generally configured to fit within the channel and includes a groove into which the ridge can slidably mate. It is to be appreciated that the tracks 90f-1 and 90f-2 are not particularly limited to this design and variations are contemplated. For example, the tracks 90f-1 and 90f-2 can be modified to have more ridges/grooves, include ball bearings for improved slidability.

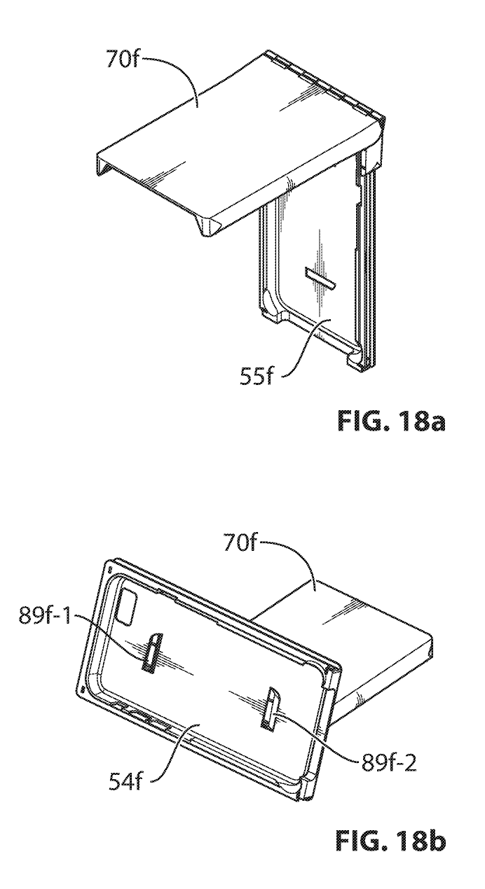

Referring to FIG. 17, the apparatus 50f is generally shown in a position for covering the mouth of a user of the portable electronic device 100f. In the present embodiment, it is to be appreciated by a person of skill in the art with the benefit of this description that the privacy shield 70f also functions to obscure the mouth of the user from view. Accordingly, in addition to providing a physical barrier to dampen sound escaping to the ambient environment, the tinting can provide additional protection against third parties being able to read the lips of the user by covering the lips of the user and obstructing the view of the lips. In the present configuration, the hinge magnets 82f-1 and 82f-2 magnetically couple with the hinge magnets 84f-1 and 84f-2 to hold the privacy shield 70f in the shown position. In addition, the phone holder 54f is held in place by having the case magnets 60f-1 and 60f-2 magnetically couple with the shield magnets 78f-1 and 78f-2, respectively. It is to be appreciated by a person of skill in the art, with the benefit of this description, that the privacy shield 70f can also function as stand to hold the portable electronic device 100f substantially upright.

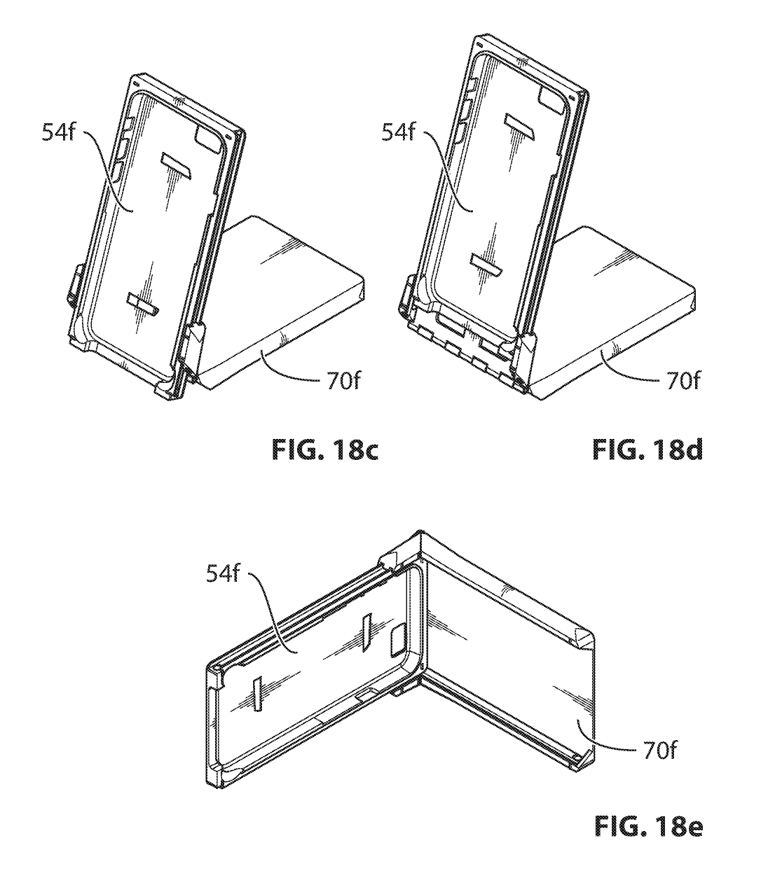

Referring to FIG. 18a, the apparatus 50f is generally shown in another position for protecting the privacy of the portable electronic device 100f by shielding the screen. In particular, it can be used to prevent a person positioned in front of the user from reading the screen of the portable electronic device 100f. In the present configuration, it is to be appreciated by a person of skill in the art with the benefit of this description that the privacy shield 70f can also block out glare or other elements such as rain when used outdoors. In the present configuration, the hinge magnets 82f-1 and 82f-2 magnetically couple with the hinge magnets 84f-1 and 84f-2 to hold the privacy shield 70f in the shown position. In addition, the phone holder 54f is held in place by having the case magnets 62f-1 and 62f-2 magnetically couple with the shield magnets 78f-2 and 78f-1, respectively. It is to be appreciated by a person of skill in the art, with the benefit of this description, that the camera opening 64f is substantially in line with the camera opening 86f-1 to allow for use of the camera on the portable electronic device 100f.

Referring to FIG. 18b, the apparatus 50f is generally shown in another position for as a horizontal stand. In the present configuration, it is to be appreciated by a person of skill in the art with the benefit of this description that the tabs 89f-1 and 89f-2 of the privacy shield 70f can rotated upward an engaged with the openings 66f-1 and 66f-2.

Referring to FIG. 18c, the apparatus 50f is generally shown in another position for as a vertical stand. In the present configuration, it is to be appreciated by a person of skill in the art with the benefit of this description that the phone holder 54f is using a portion of the tracks 90f-1 and 90f-2 of the privacy shield 70f. It is to be appreciated by a person of skill in the art that the angle of the phone holder 54f is not particularly limited and can be modified such the phone holder 54f is at a smaller or greater angle.

Referring to FIG. 18d, the apparatus 50f is generally shown in another position for as a vertical stand. In the present configuration, it is to be appreciated by a person of skill in the art with the benefit of this description that the phone holder 54f is supported above the surface by having the case magnets 60f-1 and 60f-2 magnetically couple with the shield magnets 80f-1 and 80f-2, respectively. It is to be appreciated by a person of skill in the art that by raising the phone holder 54f, it allows for access to the bottom of the portable electronic device 100f, such as for connecting a wire for charging.

Referring to FIG. 18e, the apparatus 50f is generally shown in another position for protecting the privacy of the portable electronic device 100f by shielding the screen. In particular, it can be used to prevent a person positioned in at a side of the user from reading the screen of the portable electronic device 100f. In the present configuration, it is to be appreciated by a person of skill in the art with the benefit of this description that the privacy shield 70f can also block out glare or other elements such as rain from the side when used outdoors. In the present configuration, the hinge magnets 82f-1 and 82f-2 magnetically couple with the hinge magnets 84f-1 and 84f-2 to hold the privacy shield 70f in the shown position. In addition, the phone holder 54f is held in place by having the case magnets 62f-1 and 62f-2 magnetically couple with the shield magnets 78f-2 and 78f-1, respectively. Alternatively, in another configuration, the phone holder 54f can be held in place by having the case magnets 60f-1 and 60f-2 magnetically couple with the shield magnets 78f-1 and 78f-2, respectively. It is to be appreciated by a person of skill in the art, with the benefit of this description, that the camera opening 64f is substantially in line with the camera opening 86f-1 to allow for use of the camera on the portable electronic device 100f.

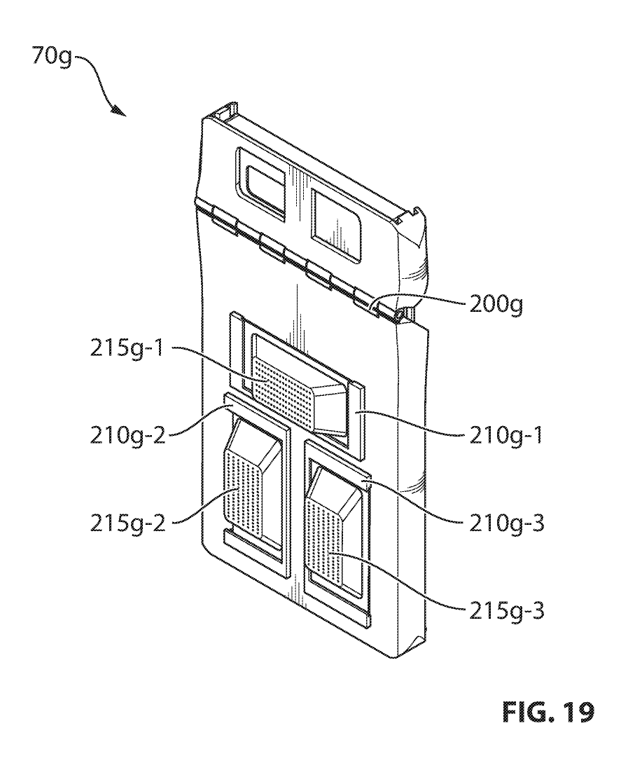

Referring to FIG. 19, another embodiment of a privacy shield 70g is shown. In the present embodiment, the privacy shield 70g includes all the features discussed above in connection the privacy shield 70f and can be used in combination with the phone holder 54f. In the present embodiment, the privacy shield 70g includes stops 200g at the hinge to restrict the angle of movement. In addition, the privacy shield 70g also includes a plurality of clips 210g-1, 210g-2, and 210g-3 for holding items 215g-1, 215g-2, and 215g-3, respectively. In the present embodiment the items 215g-1, 215g-2, and 215g-3 are pillboxes where the portable electronic device 100f can be used to provide notifications and reminders for a user to take medications that would then be conveniently stored on the device providing the reminder. However, it is to be appreciated that the items 215g-1, 215g-2, and 215g-3 are particularly not limited and can be anything else associated with a reminder system. In other embodiments, the items 215g-1, 215g-2, and 215g-3 can be modified to store other essential items, such as credit and bank cards.

Various advantages will now be apparent to a person of skill in the art. Of note is the ability to carry out a conversation in a public place with enhanced privacy. It is to be understood that any of the above describe apparatus can be designed to also function as a carrying case with a clip for a belt. Accordingly, the apparatus provides a compact solution to enhancing privacy and reducing background noise for phone calls that does not require substantial additional storage when carrying a portable electronic device. Therefore, it is to be appreciated that this ability would be especially beneficial when conducting a business call on public transit.

While specific embodiments have been described and illustrated, such embodiments should be considered illustrative only and should not serve to limit the accompanying claims.

What is claimed is:

1. An apparatus for enhancing privacy during operation of a portable electronic device, the apparatus comprising:
a privacy shield for blocking sound from a mouth of a user;
a sound guide disposed on the privacy shield, the sound guide for directing sound to from the mouth to a microphone of the portable electronic device; and
an attachment mechanism configured to attach the privacy shield to the portable electronic device.

2. The apparatus of claim 1, further comprising a moveable element connecting the privacy shield to the attachment mechanism, the moveable element configured to move the privacy shield from a blocking position to a storage position.

3. The apparatus of claim 2, wherein the moveable element comprises a track for the privacy shield to slide thereon.

4. The apparatus of claim 2, wherein the moveable element comprises a hinge to provide pivotal movement of the privacy shield relative to the attachment mechanism.

5. The apparatus of claim 1, wherein the sound guide comprises a surface configured to reflect sound.

6. The apparatus of claim 1, wherein the privacy shield is collapsible for storage.

7. The apparatus of claim 1, wherein the privacy shield covers lips of the user to obstruct lip reading.

8. The apparatus of claim 1, wherein the attachment mechanism is a hook and pile system.

9. The apparatus of claim 1, wherein the attachment mechanism comprises an attachment magnet configured to interact with a device magnet.

10. The apparatus of claim 1, wherein the attachment mechanism comprises a screw configured to be secured to the portable electronic device.

11. An apparatus for enhancing privacy during operation of a portable electronic device, the apparatus comprising:
a privacy shield for blocking sound from a mouth of a user;
an attachment mechanism configured to attach to the portable electronic device; and
a hinge connecting the privacy shield and the attachment mechanism, the hinge configured to provide pivotal movement of the privacy shield between a first position and a second position.

12. The apparatus of claim 11, wherein the hinge is a flexible material.

13. The apparatus of claim 12, wherein the flexible material is one of a plastic, rubber, or silicone.

14. The apparatus of claim 11, wherein the first position is for storing the privacy shield.

15. The apparatus of claim 14, wherein the first position stores the privacy shield against a touchscreen of the portable electronic device.

16. The apparatus of claim 15, wherein the privacy shield is configured to allow for operation of the touchscreen when in the first position.

17. The apparatus of claim 16, wherein the hinge is further configured to provide pivotal movement of the privacy shield to a third position, the third position for storing the privacy shield against a back of the portable electronic device.

18. An apparatus for enhancing privacy during operation of a portable electronic device, the apparatus comprising:
a phone holder configured to hold a phone;
a phone holder track disposed on the phone holder;
a privacy shield;
a shield track disposed in a channel on the privacy shield, wherein the shield track is configured to slidably engage the phone holder track, wherein the phone holder is configured to slide between a storage position and a use position; and
a hinge disposed within the privacy shield, the hinge configured to provide pivotal movement of a portion of the privacy shield between a first position and a second position.

19. The apparatus of claim 18, wherein the privacy shield can be engaged from both a first end and a second end of the phone holder, the first end opposite the second end.

20. The apparatus of claim 18, further comprising clips disposed on the privacy shield for storing items.
